(19) United States
(12) Patent Application Publication
(10) Pub. No.: US 2025/0265451 A1
(43) Pub. Date: Aug. 21, 2025

(54) SYSTEMS AND METHODS FOR MODIFYING A DATABASE OF CONTENT RESOURCES USING MACHINE LEARNING

(71) Applicant: Capital One Services, LLC, McLean, VA (US)

(72) Inventors: Youbing YIN, McLean, VA (US); Leeyat Bracha TESSLER, Arlington, VA (US); Daniel E. MILLER, Brooklyn, NY (US); Claire M. ROWLETT, Washington, DC (US); Robert MAYS, Midlothian, VA (US)

(73) Assignee: Capital One Services, LLC, McLean, VA (US)

(21) Appl. No.: 18/443,126

(22) Filed: Feb. 15, 2024

(51) Int. Cl. G06N 3/0475; G06N 5/01

(52) U.S. Cl. CPC G06N 3/0475; G06N 5/01

(57) ABSTRACT

Methods and systems for modifying a database of creative content resources using machine learning models. In some aspects, a system may be used to generate new resources and/or modify a subset of resources of the database. The system accesses the database and obtains data indicative of elements and (2) structural specifications for each resource. The system obtains and inputs (1) a user prompt for generating a new creative content resource and (2) a set of rules indicative of standardized assets and structural specifications into a machine learning model to obtain the new creative content resource. The system obtains an indication for replacing a recurring asset included in the new creative content resource with a replacement asset and replaces the recurring asset with the replacement asset in each creative content resource of a subset of creative content resources from the database.

### SUMMARY

Many entities, such as educational institutions, medical facilities, and/or developers of technology, are continuously generating informational content to provide key knowledge and inform their readers. For example, technology developers generate specification files specifying parameters of devices, medical entities may similarly distribute information that can help readers understand different safety precautions in relation to illness or medicines, and educational institutions may distribute informational content for educating readers on numerous topics.

The design or layout of such content is often important for many reasons. For example, the design may be important in enabling accessibility. For example, an entity may consider different font sizes, different color schemes, etc. to integrate accessible design in their content. Consistent user experience in online resources may be helpful for those with visual and/or hearing impairments. Similarly, entities may design their content based on rules (e.g., branding guidelines) to be consistent and identifiable, which may be important in distinguishing authentic content from fraudulent content. For example, for online content, branding helps in distinguishing authentic content from fraudulent or counterfeit material. Strong branding in digital spaces may include consistent use of logos, brand colors, tone of voice, and messaging across all platforms. Such consistency makes it easier for audiences to recognize and trust genuine content. By having consistent design, entities can protect their content from misrepresentation or duplication by unauthorized sources.

However, entities often publish such resources (e.g., online resources) en masse and have extensive repositories of content having different file types, structures, etc. that are linked in different ways and hard to manage. Because of this, while accessibility guidelines consistently change to reflect ongoing research and new technology, content in such repositories may not be updated to reflect the same guidelines in design, and as such entities fail to provide users with the most accessible content. Furthermore, inconsistency in design because of this leads to confusion for users with impairments.

Therefore, a mechanism is desired that would enable entities to continuously update and deploy repositories or databases of content resources (e.g., files, user interfaces, logos, etc.), e.g., in order to adopt accessibility standards in a timely manner. The systems and methods described herein implement such a mechanism to enable entities to continuously update existing resources and generate new resources that are compliant with an entity's rules (e.g., for design, branding guideline, etc.) using machine learning.

Accordingly, methods and systems are described herein for enabling modification of a database of creative content resources using machine learning models, such as by adding new creative content resources that adhere to an entity's rules on standardizing assets (e.g., design rules such as color choice, font size, logo placement, etc.) and/or modifying a recurring asset (e.g., a logo) with a replacement asset (e.g., a new logo) in one or more files of the database of creative content resources. In doing so, a database of creative content resources may be updated in a timely manner, e.g., in response to a change in accessibility guidelines, as a whole without requiring a designer to redesign different files. A creative content resources modification system may be used to perform operations described herein.

In particular, the creative content resources modification system may access a database of creative content resources associated with an entity (e.g., an institution, medical facility, company, etc.) and may have access to data associated with each creative content resource (e.g., pamphlet, documents, user interfaces, logos, etc.). For example, the data may include information indicative of the elements of each creative resource (e.g., title, logo, etc.) and/or structural specifications for composing the elements within each creative content resource (e.g., font size, color, logo position, etc.).

According to some embodiments, when the system obtains a user prompt for generating a new creative content resource for the entity (e.g., natural language text indicative of criteria for the new creative content resource) and a set of rules indicative of standardized assets and standardized structural specifications for use in the creative content resources associated with the entity (e.g., brand guidelines), the system may input the user prompt and set of rules into a machine learning model. The machine learning model may be trained using content from the creative content resources of the database to enable the system to generate new content resources consistent with those of the preexisting resources. According to some embodiments, the system may obtain an indication for replacing a recurring asset included in the new creative content resource with a replacement asset, such as for example, replacing an outdated logo with a newer logo that complies with new accessibility standards. The system may replace the recurring asset with replacement assets in each creative content resource of a subset of creative content resources from the database.

Various other aspects, features, and advantages of the system will be apparent through the detailed description and the drawings attached hereto. It is also to be understood that both the foregoing general description and the following detailed description are examples, and not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data), unless the context clearly dictates otherwise.

### BRIEF DESCRIPTION OF THE DRAWINGS

FIG. 1 shows an illustrative system for modifying a database of creative content resources using machine learning models, in accordance with one or more embodiments of this disclosure.

FIG. 2A illustrates an example of a user interface for modifying a database of creative content resources using machine learning models by generating a new creative content resource, in accordance with one or more embodiments of this disclosure.

FIG. 2B illustrates another example of a user interface for modifying a database of creative content resources using machine learning models by generating a new creative content resource, in accordance with one or more embodiments of this disclosure.

FIG. 3 shows illustrates an example of a user interface for modifying a database of creative content resources by replacing a recurring asset with a replacement asset, in accordance with one or more embodiments.

FIG. 4 is a flowchart of an exemplary computer system for modifying a database of creative content resources using machine learning models, in accordance with one or more embodiments.

FIG. 5 is a flowchart of operations for modifying a database of creative content resources using machine learning models, in accordance with one or more embodiments of this disclosure.

### DETAILED DESCRIPTION

In the following description, for the purposes of explanation, numerous specific details are set forth in order to provide a thorough understanding of the disclosed embodiments. It will be appreciated, however, by those having skill in the art, that the embodiments may be practiced without these specific details, or with an equivalent arrangement. In other cases, well-known models and devices are shown in block diagram form in order to avoid unnecessarily obscuring the disclosed embodiments. It should also be noted that the methods and systems disclosed herein are also suitable for applications unrelated to source code programming.

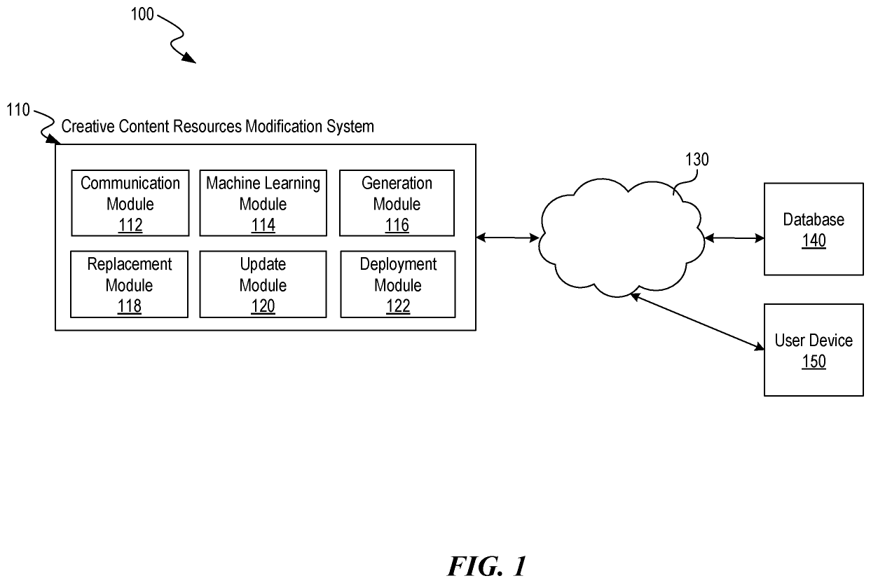

FIG. 1 is an example of environment 100 for modifying a database of creative content resources using machine learning models, in accordance with one or more embodiments of this disclosure. Environment 100 includes a creative content resource modification system 110 which may be used to modify creative content resources for an entity, e.g., by generating and adding new creative content resources or by replacing assets within the creative content resources. The environment may also include database 140 which may include, for example, the creative content resources, and user device 150 from which the creative content resource modification system 110 may receive user prompts, e.g., for modifying the database of creative content resources. The creative content resource modification system 110, database 140, and/or user device 150 may in communication via the network 130. Network 130 may be a wired or wireless connection such as via a local area network, a wide area network (e.g., the Internet), or a combination thereof.

The creative content resource modification system 110 may include communication module 112, machine learning module 114, generation module 116, replacement module 118, update module 120, and deployment module 122. As described herein, the creative content resource modification system 110 may be used to modify a database of creative content resources. For example, communication module 112 may be used to access the database 140 of the creative content resource modification system 110. Communication module 112 of creative content resource modification system 110 may include software and/or hardware components allowing for the transmission and/or receipt of information between two or more devices. For example, the communication module 112 may include a wireless communication module, such as a cellular radio or Wi-Fi antenna, to allow for communication over wireless networks, and/or may include a network card (e.g., a wireless network card and/or a wired network card) that is associated with software to drive the card.

The database 140 may include at least part of a database of creative content resources, which may encompass a diverse range of files and data that when executed or rendered on a computer system generate creative content, such as a pamphlet, user interface, slideshow, figures, logo, etc. The creative content resources and/or database 140 may be associated with an entity, such as a medical, educational, or financial institution. Users associated with or authorized by the entity may be enabled to access the database 140, e.g., through user device 150, and/or modify the database 140 or the creative content resources stored thereon.

Each creative content resource may include data such as elements that compose the creative content resource as well as structural specifications for composing the elements within each creative content resource. For example, elements may include the components of the creative content resource that compose the creative content resource such as text elements, image elements, audio elements, etc. Structural specifications may specify how to compose the element within the creative content resource, including, for example, the presentation of the element. A structural specification can include information about the elements such as position (e.g., absolute position), size, color, font, and/or the like. The creative content resource modification system 110 may obtain the elements and structural specifications via the communication module 112 and network 130 from the database 140.

According to some examples, obtaining the elements composing each creative content resource and structural specifications for composing the elements within each creative content resource may include obtaining programmatic code configured to generate each creative content resource upon execution and extracting, from the programmatic code, elements and structural specifications of each creative content resource. For example, the creative content resource may include one or more data files including a computer program that generates the creative content upon execution. In this case, obtaining the plurality of elements may include parsing the computer program to identify one or more elements. For example, parsing may be able to identify different tags from the computer program (e.g., “<p>” in HTML is a paragraph tag that is used to define a paragraph in a web page). For example, the parsing may include several steps such as tokenization (e.g., where the raw computer program text is tokenized into discrete chunks to separate tags from text and other elements), building the document object model (DOM) representing a structure of the program in memory, through one or more parsing libraries or tools and/or the like. Similarly, the structural specifications may be found by parsing the computer program for the specific values associated with the element.

In some examples, obtaining the elements and structural transmitting, to a remote device, a request for labelling portions of each creative content resource of the database; and receiving, from a remote device, one or more labels corresponding to elements and structural specifications of each creative content resource. For example, files comprising the creative content resource may be difficult to parse locally. The system may transmit, e.g., to user device 150, a request for labelling portions via communication module 112. A user and/or program at user device 150 may be configured to label portions of the creative content resources and transmit labels identifying the elements and/or corresponding structural specifications. The user may indicate the labels via a user interface on the user device 150. The creative content resource modification system 110 may receive the labels via network 130 and communication module 112.

Alternatively or additionally, the creative content resource may include an image and the system may input the image into a machine learning model to identify one or more elements and corresponding locations of the one or more elements in the image. In this instance, the machine learning model may have been trained to identify elements in images (e.g., using a training dataset). For example, the training dataset may contain a plurality of images, each representing creative content and, for each image, a plurality of elements for that image representation. The training dataset may be input into a training routine of the machine learning model to train that model. When the machine learning model is trained, it may be used to identify elements within images representing creative content. The representation of the creative content (e.g., computer program, snapshot, wireframe, etc.) may be input into the machine learning model and may identify one or more elements, and further, corresponding structural specifications. For example, the machine learning model may output a set of identified elements and corresponding attributes such as element type, position, size, styling, interactivity, and/or the like.

The communication module 112 may further be configured to obtain a user prompt for generating a new creative content resource for the entity and (2) a set of rules indicative of standardized assets and standardized structural specifications for use in the creative content resources associated with the entity. For example, the user prompt may include natural language text indicative of criteria for the new creative content resource. Alternatively, or additionally, the user prompt may include one or more files comprising data regarding an item. In one example, the user may input the user prompt or portion thereof via a user interface of user device 150.

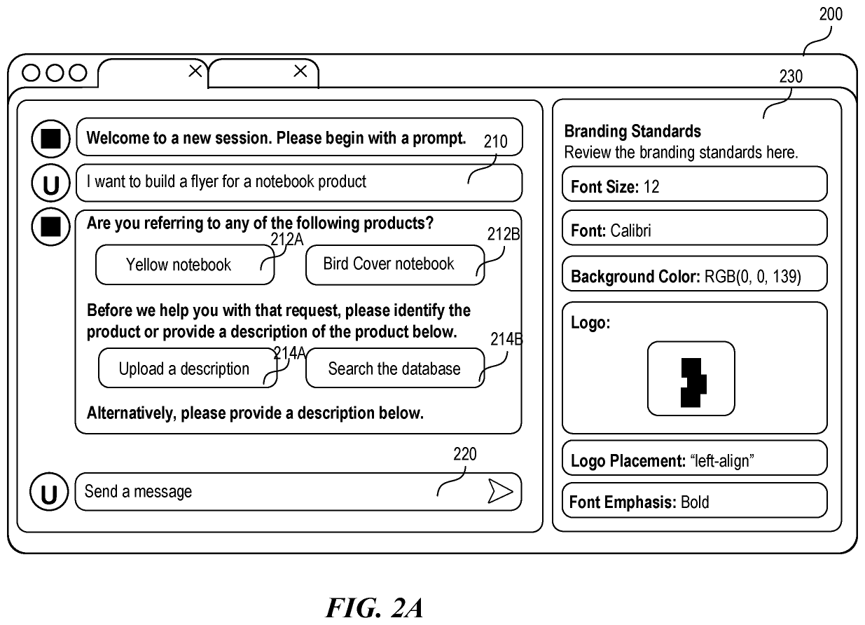

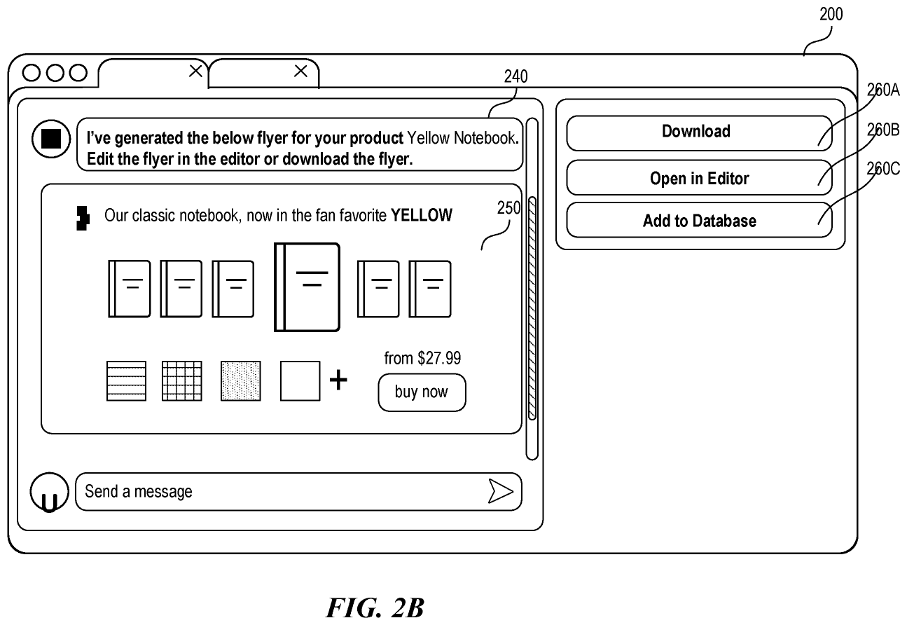

For example, FIG. 2A illustrates an example of a user interface 200 for modifying a database of creative content resources using machine learning models by generating a new creative content resource, in accordance with one or more embodiments of this disclosure. The user (e.g., an authorized user associated with the entity) may input text such as natural language text into the input field 220. For example, the user first input the text “I want to build a flyer for a notebook product.” The system may identify that a user is attempting to generate a new creative content resource (e.g., “flyer”) and determine whether or not more information is needed.

In the example of FIG. 2A, the system may identify that the creative content resource relates to an item and may identify potential items that the user referenced in the user prompt. For example, in this case, the system may identify that the user identified a “notebook.” Based on data that the system has access to (e.g., from database 140), the system may identify that the user may be referencing “Yellow notebook” 212A or “Bird cover notebook” 212B. The system may further query for more information and provide the users with options for doing so via the user interface of user device 150. For example, “Upload a description” 214A may reroute the user to a local file storage explorer of the user device 150 to enable the user to identify one or more files regarding the item. Similarly, the option “Search the database” 214B may reroute the user to identify one or more files stored on the database 140 associated with the item.

As described herein, the creative content resource modification system 110 may also obtain a set of rules indicative of standardized assets and standardized structural specifications for use in the creative content resources associated with the entity. The set of rules may include brand guidelines such as colors to use, fonts to use, sizes to use, logos to user, etc. For example, section 230 of the user interface 200 of the user device 150 identifies the branding standards that creative content resources must adhere to. Such creative content resources may be modified by the user at the user device 150 or other users authorized by the entity.

The user device 150 may take such inputs and transmit the user prompt and/or the set of rules (e.g., brand guidelines) to the creative content resource modification system 110 via communication module 112. The communication module 112 may pass at least a portion of the user prompt and/or the set of rules, or a pointer to the same, to the machine learning module 114. The machine learning module may be configured to input the user prompt and the set of rules into one or more machine learning models to obtain the new creative content resource. The machine learning model may be trained using the elements and the structural specifications of creative content resources of the database and may be configured to generate new creative content resources. For example, the machine learning model may be a generative model, configured to generate designs.

The input to the generative model may include a dataset of existing creative content resources, which may encompass various styles of flyers, color palettes, typography, and layout structures. Additionally, user-specific inputs such as brand guidelines, desired themes, text content, and any other specific design requirements may be fed into the system. During training model (e.g., Generative Adversarial Networks (GANs) or Variational Autoencoders (VAEs)) may learn and replicate design patterns from the input dataset.

Once trained, the model can generate new designs or portions thereof. When given specific parameters (like a certain style or color scheme), the model may use its learned knowledge to create designs that align with the set of rules. The output of the machine learning model may include a new creative content resource (e.g., one or more files that can be executed or rendered) that meet the given criteria. For example, in the context of flyer design, the output would be various flyer layouts complete with color schemes, typography, and suggested imagery. These designs can either be used as-is or further refined by a human designer. In some examples, the model may be refined over time. For example, the machine learning module 114 may execute an iterative feedback loop where the outputs are reviewed, and the system is fine-tuned to better align with the set of rules or to improve creativity and originality.

In some examples, the model may be trained based on the elements and/or the structural specifications for each creative content resource of the database. For example, the machine learning module 114 may extract structural specifications and use them to train the machine learning module 114 specifically. For example, the system may determine that a first element of the elements of a creative content resource is a textual element and responsive to determining that the first element is a textual element, extracting structural specifications including a font name associated with the first element, a font size associated with the first element, a font color associated with the first element, a background color associated with the first element and/or a position of the first element. Alternatively, or additionally, the system may determine that the first element of the elements of a creative content resource is an image element (e.g., video, image, illustration, etc.) and responsive to determining that the first element is an image element, extracting structural specifications including a color space associated with the first element, a resolution associated with the first element, a position of the first element, and/or an aspect ratio associated with the first element.

The creative content resource modification system 110 may transmit the generated creative content resource (e.g., output of the trained model) to the user device 150 via the communication module 112 via the network 130. For example, FIG. 2B illustrates another example of a user interface 200 for modifying a database of creative content resources using machine learning models by generating a new creative content resource, in accordance with one or more embodiments of this disclosure. For example, the user interface notifies the user that generation has been completed. For example, section 240 states “I've generated the below flyer for your product Yellow Notebook. Edit the flyer in the editor or download the flyer.” In section 250, the user interface 200 presents the generated new creative content resource for the user's review. In this example, the creative content resource includes the flyer, which adheres to the set of rules established by the set of rules (e.g., brand guidelines) and is based on other creative content resources associated with the entity and stored in database 140.

The user interface 200 includes option 260A, option 260B, and option 260C from which the user may select via the user interface. For example, the user may download the new creative content resource. Alternatively, or additionally, the user may open the new creative content resource in an editor to edit the new creative content resource. For example, the user may move, add, remove, elements of the new creative content resource. Alternatively or additionally, the user may modify values for the structural specifications, e.g., to alter a size, shape, color, emphasis, etc. of the corresponding element(s). Once the user approves of the final creative content resource, the user may indicate to the system to add the finalized resource to the database, e.g., database 140.

In particular, the user device may display, via a graphical display such as user interface 200, the new creative content resource comprising one or more elements of the new creative content resource and one or more structural specifications for composing the one or more elements of the new creative content resource. The system may receive one or more user inputs via the communication module 112 and pass at least a portion of data indicative of the user inputs, or a pointer to the data, where the user inputs are indicative of a modification of the new creative content resource, such as from the editor. The new creative content resource may be updated based on the one or more user inputs by modifying the newly generated creative content resource using the data indicative of the one or more user inputs.

Communication module 112 may receive an indication of approval of the final creative content resource as well as the edits, if any, that a user made via an editor to the creative content resource. Communication module 112 may pass all or at least a portion of this information, or a pointer to the same, to the generation module 116. Generation module 116 may compile the changes the user made via the editor and may generate an entry to input into the database 140. For example, the generation module 116 may generate an insert query to insert the entry into the database.

According to some examples, the set of rules, e.g., branding guidelines, may be generated using a second machine learning model based on the creative content resources of the database. For example, the machine learning module 114 may further include capability for generating the set of rules using a separate or same machine learning model as the generative model. For example, the model may be trained to identify similarities between the different creative content resources of the database such as similar colors, large strings of repeating text, similar fonts, similar font colors, similar background colors, etc. to generate the set of rules. For example, the set of rules may be initiated to define certain parameters for an entity such as “background color,” “logo,” or “font size.” The machine learning module 114 may be trained to identify such elements and/or structural specifications from each creative content resource and define the parameter using the identified specifications and elements. In some examples, the elements and structural specifications may be identified specific to the type of creative content resource (e.g., websites, pitch material, etc.). By doing so, the set of rules may be indicative of standardized assets and standardized structural specifications for use in creative content resources associated with the entity based on the elements and the structural specifications for each creative content resource.

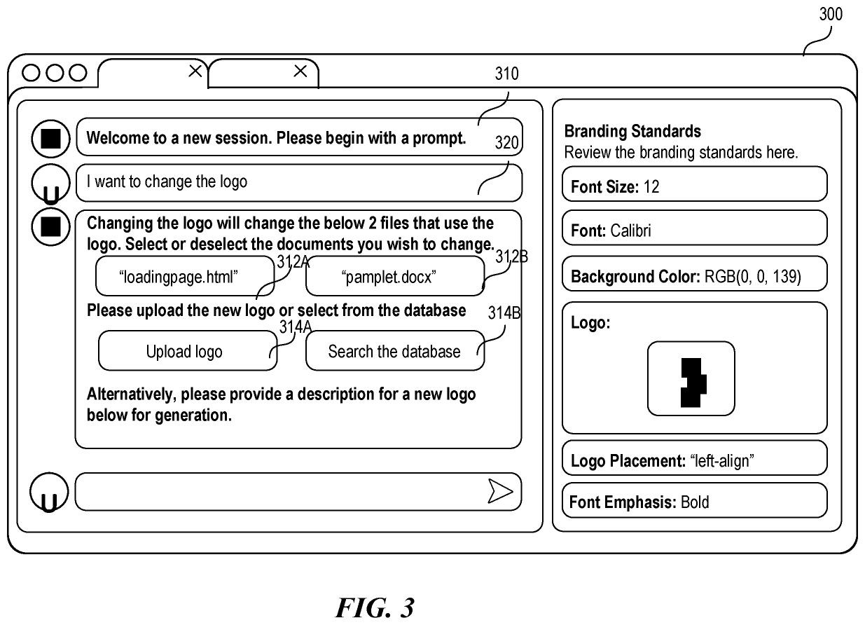

As described herein, creative content resource modification system 110 may modify creative content resources by replacing recurring assets with replacement assets. For example, a recurring asset may be a logo that is included in more than one creative content resource. When the recurring asset is updated, e.g., a new logo is designed, the recurring asset may need to be replaced in the creative content resources using a replacement asset. FIG. 3 shows illustrates an example of a user interface 300 for modifying a database of creative content resources by replacing a recurring asset with a replacement asset, in accordance with one or more embodiments.

User interface 300, e.g., of user device 150, may be used to query a user at the interface (e.g., a user authorized by the entity) to prompt the system for modification of the database associated with the user. For example, the user interface prompts the user using query 310, “Welcome to a new session. Please begin with a prompt.” The user in the example of FIG. 3 has responded with the user prompt 320 “I want to change the logo.” As described herein, the logo may be a recurring asset that features as part of one or more different creative content resources of the database. For example, the recurring asset, e.g., the logo, may be one or more elements featured in different creative content resources such as a pamphlet, slideshow, business card design, website design, etc. The system may receive the user prompt(s) via network 130 and/or communication module 112. The system may identify that the user prompt is a prompt for replacing a recurring asset with a replacement asset based on the user prompt.

The user interface 300 may also prompt the user for further information regarding the replacement asset. For example, the user interface may provide option 314A for the user to upload the replacement asset or option 314B for searching the database to identify the replacement asset in the existing creative content resources. Alternatively or additionally, the user may provide a description for a new replacement asset, which may be generated using generative machine learning models. In some examples, the new replacement asset may be generated to adhere to the set of rules or to be consistent with creative content resources in the database (e.g., follow a color palette that is within a threshold level of closeness).

When the system obtains an indication for replacing a recurring asset included in one or more creative content resources (e.g., including the new creative content resource) with a replacement asset, e.g., based on receiving the user prompt at the communication module 112, the communication module 112 may pass at least a portion of the indication to the replacement module 118. The replacement module 118 may determine the subset of creative content resources from the database of creative content resources comprising the recurring asset. Once the replacement module 118 identifies the subset of creative content resources that include the recurring asset, the replacement module 118 may pass the subset, or identifiers of the creative content resources in the database, to the update module 120. The update module 120 may be configured to update the database by replacing the recurring asset with the replacement asset in each creative content resource of a subset of creative content resources from the database.

According to some examples, the system may transmit (e.g., via network 130, via communication module 112) the identified creative content resource(s) of the subset and display them to the user via the user interface of the user device. For example, in FIG. 3, the user display identifies the “loadingpage.html” creative content resource and the “pamphlet.docx” creative content resource as including the recurring asset. In this example, the user may select, via option 312A and/or option 312B of user interface 300, the creative content resources that the user would like to be modified by replacement of the recurring asset with the replacement asset.

According to some examples, creative content resource modification system 110 may automatically deploy one or more creative content resource based on one or more conditions. For example, the deployment module 122 may be configured to deploy creative content resources from the subset of creative content resources responsive to an indication of successful replacement of the recurring asset with the replacement asset. For example, successful replacement may include when a previous logo has been successfully replaced by the replacement logo in the creative content resource, e.g., by modifying instances in a file linking the previous logo to a file path or file name of the new logo document. Similarly, for a creative content resource such as a website page, a HTML document may be modified to list a file path of the replacement asset rather than the previous asset, and the replacement asset may be added to the listed file path. The deployment module 122 may transmit a command for executing computer code or program(s) to deploy the creative content resource.

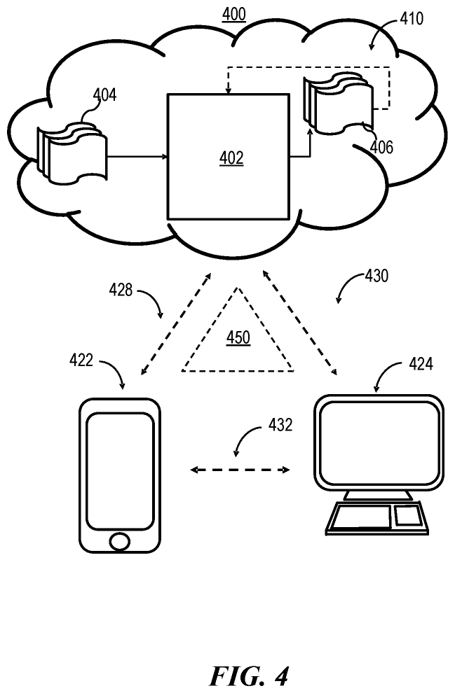

FIG. 4 shows illustrative components for a system used to modify the creative content resources database, in accordance with one or more embodiments. As shown in FIG. 4, system 400 may include mobile device 422 and user terminal 424. While shown as a smartphone and personal computer, respectively, in FIG. 4, it should be noted that mobile device 422 and user terminal 424 may be any computing device, including, but not limited to, a laptop computer, a tablet computer, a hand-held computer, and other computer equipment (e.g., a server), including “smart,” wireless, wearable, and/or mobile devices. FIG. 4 also includes cloud components 410. Cloud components 410 may alternatively be any computing device as described above, and may include any type of mobile terminal, fixed terminal, or other device.

For example, cloud components 410 may be implemented as a cloud computing system, and may feature one or more component devices. It should also be noted that system 400 is not limited to three devices. Users may, for instance, utilize one or more devices to interact with one another, one or more servers, or other components of system 400. It should be noted, that, while one or more operations are described herein as being performed by particular components of system 400, these operations may, in some embodiments, be performed by other components of system 400. As an example, while one or more operations are described herein as being performed by components of mobile device 422, these operations may, in some embodiments, be performed by components of cloud components 410. In some embodiments, the various computers and systems described herein may include one or more computing devices that are programmed to perform the described functions. Additionally, or alternatively, multiple users may interact with system 400 and/or one or more components of system 400. For example, in one embodiment, a first user and a second user may interact with system 400 using two different components.

With respect to the components of mobile device 422, user terminal 424, and cloud components 410, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 4, both mobile device 422 and user terminal 424 include a display upon which to display data (e.g., conversational response, queries, and/or notifications).

Additionally, as mobile device 422 and user terminal 424 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 400 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 4 also includes communication paths 428, 430, and 432. Communication paths 428, 430, and 432 may include the Internet, a mobile phone network, a mobile voice or data network (e.g., a 5G or LTE network), a cable network, a public switched telephone network, or other types of communications networks or combinations of communications networks. Communication paths 428, 430, and 432 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 410 may include creative content resource modification system 110, e.g., including one or more subsystems of creative content resource modification system 110, user device 150, and/or database 140 via network 130. Cloud components 410 may access data such as from database 140, e.g., via network 130.

Cloud components 410 may include model 402, which may be a machine learning model, artificial intelligence model, etc. (which may be referred collectively as “models” herein). Model 402 may take inputs 404 and provide outputs 406. The inputs may include multiple datasets, such as a training dataset and a test dataset. Each of the plurality of datasets (e.g., inputs 404) may include data subsets related to user data, predicted forecasts and/or errors, and/or actual forecasts and/or errors. In some embodiments, outputs 406 may be fed back to model 402 as input to train the model 402 (e.g., alone or in conjunction with user indications of the accuracy of outputs 406, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., models that model the relationship between the features and the value of the target value of interest).

In a variety of embodiments, model 402 may update its configurations (e.g., weights, biases, or other parameters) based on the assessment of its prediction (e.g., outputs 406) and reference feedback information (e.g., user indication of accuracy, reference labels, or other information). In a variety of embodiments, where model 402 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 402 may be trained to generate better predictions.

In some embodiments, model 402 may include an artificial neural network. In such embodiments, model 402 may include an input layer and one or more hidden layers. Each neural unit of model 402 may be connected with many other neural units of model 402. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 402 may be self-learning and trained, rather than explicitly programmed, and can perform significantly better in certain areas of problem solving, as compared to traditional computer programs. During training, an output layer of model 402 may correspond to a classification of model 402, and an input known to correspond to that classification may be input into an input layer of model 402 during training. During testing, an input without a known classification may be input into the input layer, and a determined classification may be output.

In some embodiments, model 402 may include multiple layers (e.g., where a signal path traverses from front layers to back layers). In some embodiments, back propagation techniques may be utilized by model 402 where forward stimulation is used to reset weights on the “front” neural units. In some embodiments, stimulation and inhibition for model 402 may be more free-flowing, with connections interacting in a more chaotic and complex fashion. During testing, an output layer of model 402 may indicate whether or not a given input corresponds to a classification of model 402 (e.g., models that model the relationship between the features and the value of the target value of interest).

In some embodiments, the model (e.g., model 402) may automatically perform actions based on outputs 406. In some embodiments, the model (e.g., model 402) may not perform any actions. The parameters of the model (e.g., model 402) may be used to generate the feature matrices to identify the feature contributions of each feature on the target value of interest.

System 400 also includes API layer 450. API layer 450 may allow the system to generate summaries across different devices. In some embodiments, API layer 450 may be implemented on mobile device 422 or user terminal 424. Alternatively or additionally, API layer 450 may reside on one or more of cloud components 410. API layer 450 (which may be A REST or Web services API layer) may provide a decoupled interface to data and/or functionality of one or more applications. API layer 450 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 450 may use various architectural arrangements. For example, system 400 may be partially based on API layer 450, such that there is strong adoption of SOAP and RESTful Web-services, using resources like Service Repository and Developer Portal, but with low governance, standardization, and separation of concerns. Alternatively, system 400 may be fully based on API layer 450, such that separation of concerns between layers like API layer 450, services, and applications are in place.

In some embodiments, the system architecture may use a microservice approach. Such systems may use two types of layers: Front-End Layer and Back-End Layer where microservices reside. In this kind of architecture, the role of the API layer 450 may provide integration between Front-End and Back-End. In such cases, API layer 450 may use RESTful APIs (exposition to front-end or even communication between microservices). API layer 450 may use AMQP (e.g., Kafka, RabbitMQ, etc.). API layer 450 may use incipient usage of new communications protocols such as gRPC, Thrift, etc.

In some embodiments, the system architecture may use an open API approach. In such cases, API layer 450 may use commercial or open source API Platforms and their modules. API layer 450 may use a developer portal. API layer 450 may use strong security constraints applying WAF and DDoS protection, and API layer 450 may use RESTful APIs as standard for external integration.

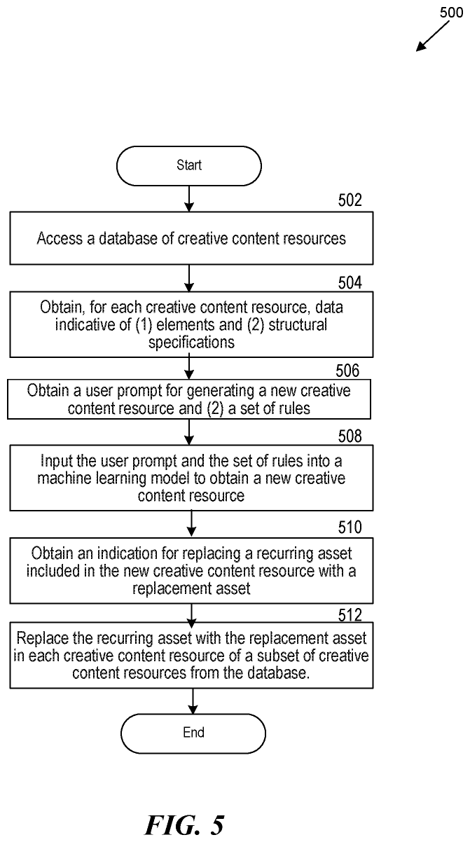

FIG. 5 is a flowchart of operations for modifying a database, e.g., database 140 of creative content resources using machine learning models, in accordance with one or more embodiments of this disclosure. For example, the system may use process 500 (e.g., as implemented on one or more system components described above with respect to FIG. 1 or FIG. 4) in order to enable modifications (e.g., additions or replacement of recurring assets) of a creative content resources database.

At step 502, process 500 may include accessing a database of creative content resources. For example, communication module 112 of creative content resource modification system 110 may be used to access a database, such as database 140, of creative content resources associated with an entity. For example, the entity may be a company, institution, and/or the like that may authorize specific users or user devices (e.g., including one such as user device 150) in communication with the system. As described herein, creative content resources may include one or more files or other data structures that may represent creative content. In some examples, they may include one or more files or other data structures that, when rendered or otherwise executed, may display the creative content. For example, the creative content resource may include figures, drawings, slideshows, images, text, audio, website code, etc.

At step 504, process 500 may include obtaining, for each creative content resource, data indicative of (1) elements and (2) structural specifications. For example, the process may include obtaining, for each creative content resource of the database, data indicative of (1) elements composing each creative content resource and (2) structural specifications for composing the elements within each creative content resource. As described herein, elements composing each creative content resource may include textual, auditory, visual components. For example, where the creative content resource includes code for rendering a website (e.g., HTML document, CSS document, markup, etc.), the elements may include images, backgrounds, text, buttons, dropdown menus, etc. As described herein, structural specifications may specify how to compose the element within the creative content resource, including, for example, the presentation of the element. A structural specification can include information about the elements such as position (e.g., absolute position), size, color, font, and/or the like.

As described herein, obtaining data indicative of (1) elements composing each creative content resource and (2) structural specifications for composing the elements within each creative content resource comprises may include obtaining programmatic code configured to generate each creative content resource upon execution and extracting, from the programmatic code, elements and structural specifications of each creative content resource. Similarly, obtaining data indicative of (1) elements composing each creative content resource and (2) structural specifications for composing the elements within each creative content resource may also include transmitting, to a remote device, a request for labelling portions of each creative content resource of the database and receiving, from a remote device, one or more labels corresponding to elements and structural specifications of each creative content resource.

At step 506, process 500 may include obtaining a user prompt for generating a new creative content resource and (2) a set of rules. For example, the process may include obtaining (1) a user prompt for generating a new creative content resource for the entity, wherein the user prompt comprises natural language text indicative of criteria for the new creative content resource and (2) a set of rules indicative of standardized assets and standardized structural specifications for use in the creative content resources associated with the entity. As described herein, the user prompt may include natural language such as “make a flyer for a notebook” or “generate html code for a notebook product.” The set of rules may include branding guidelines, such as those generated using machine learning, e.g., using a model trained on other creative content resources by the same entity.

At step 508, the process includes inputting the user prompt and the set of rules into a machine learning model to obtain a new creative content resource. For example, the process may include inputting the user prompt and the set of rules into a machine learning model (e.g., generative model) to obtain the new creative content resource, wherein the machine learning model is trained using the elements and the structural specifications of creative content resources of the database. The machine learning model may be configured to generate new creative content resources.

According to some examples, the user prompt may indicate to generate a new creative content resource associated with an item, e.g., such as a notebook. The user prompt may include one or more files comprising data regarding the item (e.g., a textual description, pricing information, specifications, etc.) and the machine learning model may be further configured to access the data from the one or more files and process the data to include as an element of the new creative content resource.

At step 510, process 500 may include obtaining an indication for replacing a recurring asset included in the new creative content resource with a replacement asset. For example, as described herein, the recurring asset may include an element or combination of elements that together, form an asset. For example, the recurring asset may be a logo, or a motto, or a mission statement, and/or the like. The replacement asset may be an updated version of the recurring asset which will replace the recurring asset in creative content resources.

At step 512, the process may include replacing the recurring asset with the replacement asset in each creative content resource of a subset of creative content resources from the database. For example, the replacement asset may be an updated version of the recurring asset that replaces the recurring asset in creative content resources.

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 5.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method for modifying a database of creative content resources using machine learning models, the method comprising: accessing a database of creative content resources associated with an entity; obtaining, for each creative content resource of the database, data indicative of (1) elements composing each creative content resource and (2) structural specifications for composing the elements within each creative content resource; training a machine learning model based on the elements and the structural specifications for each creative content resource of the database, wherein the machine learning model is configured to generate new creative content resources; obtaining (1) a user prompt for generating a new creative content resource for the entity, wherein the user prompt comprises natural language text indicative of criteria for the new creative content resource and (2) a set of rules indicative of standardized assets and standardized structural specifications for use in the creative content resources associated with the entity; inputting the user prompt and the set of rules into the machine learning model to generate the new creative content resource; displaying, via a graphical display, the new creative content resource comprising one or more elements of the new creative content resource and one or more structural specifications for composing the one or more elements of the new creative content resource; obtaining an indication for replacing a recurring asset included in the one or more elements of the new creative content resource with a replacement asset; determining a subset of creative content resources from the database of creative content resources comprising the recurring asset; and replacing the recurring asset with the replacement asset in each creative content resource of the subset of creative content resources.

2. A method for modifying a database of creative content resources using machine learning models, the method comprising: accessing a database of creative content resources associated with an entity; obtaining, for each creative content resource of the database, data indicative of (1) elements composing each creative content resource and (2) structural specifications for composing the elements within each creative content resource; obtaining (1) a user prompt for generating a new creative content resource for the entity, wherein the user prompt comprises natural language text indicative of criteria for the new creative content resource and (2) a set of rules indicative of standardized assets and standardized structural specifications for use in the creative content resources associated with the entity; inputting the user prompt and the set of rules into a machine learning model to obtain the new creative content resource, wherein the machine learning model is trained using the elements and the structural specifications of creative content resources of the database and wherein the machine learning model is configured to generate new creative content resources; obtaining an indication for replacing a recurring asset included in the new creative content resource with a replacement asset; and replacing the recurring asset with the replacement asset in each creative content resource of a subset of creative content resources from the database.

3. A method for modifying a database of creative content resources using machine learning models, the method comprising: accessing a database of creative content resources associated with an entity; obtaining, for each creative content resource of the database, data indicative of (1) elements composing each creative content resource and (2) structural specifications for composing the elements within each creative content resource; obtaining (1) a user prompt for generating a new creative content resource for the entity, wherein the user prompt comprises natural language text indicative of criteria for the new creative content resource and (2) a set of rules indicative of standardized assets and standardized structural specifications for use in the creative content resources associated with the entity; inputting the user prompt and the set of rules into a machine learning model to obtain the new creative content resource, wherein the machine learning model is trained using the elements and the structural specifications of creative content resources of the database and wherein the machine learning model is configured to generate new creative content resources; obtaining an indication for replacing a recurring asset included in the new creative content resource with a replacement asset; and replacing the recurring asset with the replacement asset in each creative content resource of a subset of creative content resources from the database.

4. The method of the preceding embodiment, further comprising determining the subset of creative content resources from the database of creative content resources comprising the recurring asset.

5. The method of any of the preceding embodiments, further comprising training the machine learning model based on the elements and the structural specifications for each creative content resource of the database.

6. The method of any of the preceding embodiments, wherein obtaining data indicative of (1) elements composing each creative content resource and (2) structural specifications for composing the elements within each creative content resource comprises: obtaining programmatic code configured to generate each creative content resource upon execution; and extracting, from the programmatic code, elements and structural specifications of each creative content resource.

7. The method of any of the preceding embodiments, further comprising determining that a first element of the elements of a creative content resource is a textual element; and responsive to determining that the first element is a textual element, extracting structural specifications including a font name associated with the first element, a font size associated with the first element, a font color associated with the first element, a background color associated with the first element and/or a position of the first element.

8. The method of any of the preceding embodiments, further comprising: determining that a first element of the elements of a creative content resource is an image element; and responsive to determining that the first element is an image element, extracting structural specifications including a color space associated with the first element, a resolution associated with the first element, a position of the first element, and/or an aspect ratio associated with the first element.

9. The method of any of the preceding embodiments, wherein obtaining data indicative of (1) elements composing each creative content resource and (2) structural specifications for composing the elements within each creative content resource comprises: transmitting, to a remote device, a request for labelling portions of each creative content resource of the database; and receiving, from a remote device, one or more labels corresponding to elements and structural specifications of each creative content resource.

10. The method of any of the preceding embodiments, further comprising: generating, using a second machine learning model, the set of rules indicative of standardized assets and standardized structural specifications for use in creative content resources associated with the entity based on the elements and the structural specifications for each creative content resource.

11. The method of any of the preceding embodiments, further comprising automatically deploying each creative content resource of the subset of creative content resources responsive to an indication of successful replacement of the recurring asset with the replacement asset.

12. The method of any of the preceding embodiments, further comprising displaying, via a graphical display, the new creative content resource comprising one or more elements of the new creative content resource and one or more structural specifications for composing the one or more elements of the new creative content resource; receiving one or more user inputs indicative of a modification of the new creative content resource; and updating the new creative content resource based on the one or more user inputs.

13. The method of any of the preceding embodiments further comprising updating the database of creative content resources by adding the new creative content resource to the database.

14. The method of any of the preceding embodiments, wherein the user prompt further comprises one or more files comprising data regarding an item and wherein the machine learning model is further configured to access the data from the one or more files and process the data to include as an element of the new creative content resource.

15. One or more tangible, non-transitory, computer-readable media storing instructions that, when executed by a data processing apparatus, cause the data processing apparatus to perform operations comprising those of any of embodiments 1-14.

16. A system comprising: one or more processors; and memory storing instructions that, when executed by the one or more processors, cause the processors to effectuate operations comprising those of any of embodiments 1-14.

17. A system comprising means for performing any of embodiments 1-14.

18. A system comprising cloud-based circuitry for performing any of embodiments 1-14.

What is claimed is:

1. A system for modifying a database of content resources using machine learning models, the system comprising:
one or more processors; and
one or more non-transitory, computer-readable media comprising instructions that, when executed by the one or more processors, causes operations comprising:
accessing a database of creative content resources associated with an entity;
obtaining, for each creative content resource of the database, data indicative of (1) elements composing each creative content resource and (2) structural specifications for composing the elements within each creative content resource;
training a machine learning model based on the elements and the structural specifications for each creative content resource of the database, wherein the machine learning model is configured to generate new creative content resources;
obtaining (1) a user prompt for generating a new creative content resource for the entity, wherein the user prompt comprises natural language text indicative of criteria for the new creative content resource and (2) a set of rules indicative of standardized assets and standardized structural specifications for use in the creative content resources associated with the entity;
inputting the user prompt and the set of rules into the machine learning model to generate the new creative content resource;
displaying, via a graphical display, the new creative content resource comprising one or more elements of the new creative content resource and one or more structural specifications for composing the one or more elements of the new creative content resource;
obtaining an indication for replacing a recurring asset included in the one or more elements of the new creative content resource with a replacement asset;
determining a subset of creative content resources from the database of creative content resources comprising the recurring asset; and
replacing the recurring asset with the replacement asset in each creative content resource of the subset of creative content resources.

2. A method for modifying a database of creative content resources using machine learning models, the method comprising:
accessing a database of creative content resources associated with an entity;
obtaining, for each creative content resource of the database, data indicative of (1) elements composing each creative content resource and (2) structural specifications for composing the elements within each creative content resource;
obtaining (1) a user prompt for generating a new creative content resource for the entity, wherein the user prompt comprises natural language text indicative of criteria for the new creative content resource and (2) a set of rules indicative of standardized assets and standardized structural specifications for use in the creative content resources associated with the entity;
inputting the user prompt and the set of rules into a machine learning model to obtain the new creative content resource, wherein the machine learning model is trained using the elements and the structural specifications of creative content resources of the database and wherein the machine learning model is configured to generate new creative content resources:
obtaining an indication for replacing a recurring asset included in the new creative content resource with a replacement asset; and
replacing the recurring asset with the replacement asset in each creative content resource of a subset of creative content resources from the database.

3. The method of claim 2, further comprising determining the subset of creative content resources from the database of creative content resources comprising the recurring asset.

4. The method of claim 2, further comprising training the machine learning model based on the elements and the structural specifications for each creative content resource of the database.

5. The method of claim 2, wherein obtaining data indicative of (1) elements composing each creative content resource and (2) structural specifications for composing the elements within each creative content resource comprises:
obtaining programmatic code configured to generate each creative content resource upon execution; and
extracting, from the programmatic code, elements and structural specifications of each creative content resource.

6. The method of claim 4, further comprising:
determining that a first element of the elements of a creative content resource is a textual element; and
responsive to determining that the first element is a textual element, extracting structural specifications including a font name associated with the first element, a font size associated with the first element, a font color associated with the first element, a background color associated with the first element and/or a position of the first element.

7. The method of claim 4, further comprising:
determining that a first element of the elements of a creative content resource is an image element; and
responsive to determining that the first element is an image element, extracting structural specifications including a color space associated with the first element, a resolution associated with the first element, a position of the first element, and/or an aspect ratio associated with the first element.

8. The method of claim 2, wherein obtaining data indicative of (1) elements composing each creative content resource and (2) structural specifications for composing the elements within each creative content resource comprises:
transmitting, to a remote device, a request for labelling portions of each creative content resource of the database; and
receiving, from a remote device, one or more labels corresponding to elements and structural specifications of each creative content resource.

9. The method of claim 2, further comprising generating, using a second machine learning model, the set of rules indicative of standardized assets and standardized structural specifications for use in creative content resources associated with the entity based on the elements and the structural specifications for each creative content resource.

10. The method of claim 2, further comprising automatically deploying each creative content resource of the subset of creative content resources responsive to an indication of successful replacement of the recurring asset with the replacement asset.

11. The method of claim 2, further comprising:
displaying, via a graphical display, the new creative content resource comprising one or more elements of the new creative content resource and one or more structural specifications for composing the one or more elements of the new creative content resource;
receiving one or more user inputs indicative of a modification of the new creative content resource; and
updating the new creative content resource based on the one or more user inputs.

12. The method of claim 2, further comprising updating the database of creative content resources by adding the new creative content resource to the database.

13. The method of claim 2, wherein the user prompt further comprises one or more files comprising data regarding an item and wherein the machine learning model is further configured to access the data from the one or more files and process the data to include as an element of the new creative content resource.

14. One or more non-transitory, computer-readable media comprising instructions recorded thereon that, when executed by one or more processors, cause operations for modifying a database of creative content resources using machine learning models, comprising:
accessing a database of creative content resources associated with an entity;
obtaining, for each creative content resource of the database, data indicative of (1) elements composing each creative content resource and (2) structural specifications for composing the elements within each creative content resource;
obtaining (1) a user prompt for generating a new creative content resource for the entity, wherein the user prompt comprises natural language text indicative of criteria for the new creative content resource and (2) a set of rules indicative of standardized assets and standardized structural specifications for use in the creative content resources associated with the entity;
inputting the user prompt and the set of rules into a machine learning model to obtain the new creative content resource, wherein the machine learning model is trained using the elements and the structural specifications of creative content resources of the database and wherein the machine learning model is configured to generate new creative content resources;
obtaining an indication for replacing a recurring asset included in the new creative content resource with a replacement asset; and
replacing the recurring asset with the replacement asset in each creative content resource of a subset of creative content resources from the database.

15. The one or more non-transitory, computer-readable media of claim 14,
wherein obtaining data indicative of (1) elements composing each creative content resource and (2) structural specifications for composing the elements within each creative content resource comprises:
transmitting, to a remote device, a request for labelling portions of each creative content resource of the database; and
receiving, from a remote device, one or more labels corresponding to elements and structural specifications of each creative content resource.

16. The one or more non-transitory, computer-readable media of claim 15, wherein obtaining data indicative of (1) elements composing each creative content resource and (2) structural specifications for composing the elements within each creative content resource comprises:
obtaining programmatic code configured to generate each creative content resource upon execution; and
extracting, from the programmatic code, elements and structural specifications of each creative content resource.

17. The one or more non-transitory, computer-readable media of claim 14, wherein the instructions further cause operations comprising:
automatically deploying each creative content resource of the subset of creative content resources responsive to an indication of successful replacement of the recurring asset with the replacement asset.

18. The one or more non-transitory, computer-readable media of claim 14, wherein the instructions further cause operations comprising:
displaying, via a graphical display, the new creative content resource comprising one or more elements of the new creative content resource and one or more structural specifications for composing the one or more elements of the new creative content resource;
receiving one or more user inputs indicative of a modification of the new creative content resource; and
updating the new creative content resource based on the one or more user inputs.

19. The one or more non-transitory, computer-readable media of claim 14, wherein the instructions further cause operations comprising:
generating, using a second machine learning model, the set of rules indicative of standardized assets and standardized structural specifications for use in creative content resources associated with the entity based on the elements and the structural specifications for each creative content resource.

20. The one or more non-transitory, computer-readable media of claim 14, wherein the user prompt further comprises one or more files comprising data regarding an item and wherein the machine learning model is further configured to access the data from the one or more files and process the data to include as an element of the new creative content resource.
